(19) United States
(12) Patent Application Publication
(10) Pub. No.: US 2020/0294540 A1
(43) Pub. Date: Sep. 17, 2020

(54) MAGNETIC DISK DEVICE AND METHOD

(71) Applicants: Kabushiki Kaisha Toshiba, Tokyo (JP); Toshiba Electronic Devices & Storage Corporation, Tokyo (JP)

(72) Inventor: Hideo Shimokawa, Ome Tokyo (JP)

(21) Appl. No.: 16/556,295

(22) Filed: Aug. 30, 2019

(30) Foreign Application Priority Data
Mar. 15, 2019 (JP) 2019-048509

(51) Int. Cl. G11B 5/49; G06F 12/0866; G11B 20/10; G11B 20/12

(52) U.S. Cl. CPC G11B 5/4992; G06F 12/0866; G11B 20/10527; G11B 20/1217; G11B 2020/1238; G06F 2212/21; G06F 2212/281; G11B 2020/1062; G11B 2020/1292; G06F 2212/1024

(57) ABSTRACT

According to one embodiment, a magnetic disk device includes a magnetic disk, a first magnetic head, a second magnetic head, a buffer memory, and a control circuit. The magnetic disk includes a plurality of first storage regions. The control circuit controls the first magnetic head to read first data from a second storage region of the first storage regions to the buffer memory. The control circuit controls the second magnetic head to write second data to a third storage region concurrently with the reading of the first data. The third region is of the first storage regions, different from the second storage region. The second data corresponds to the first data stored in the buffer memory.

### CROSS-REFERENCE TO RELATED APPLICATIONS

This application is based upon and claims the benefit of priority from Japanese Patent Application No. 2019-048509, filed on Mar. 15, 2019; the entire contents of which are incorporated herein by reference.

### FIELD

Embodiments described herein relate generally to a magnetic disk device and a method for a magnetic disk.

### BACKGROUND

Magnetic disk devices including two or more magnetic heads and two or more actuators that can move the magnetic heads independently are known.

### BRIEF DESCRIPTION OF THE DRAWINGS

FIG. 1 illustrates an exemplary configuration of a magnetic disk device according to a first embodiment;

FIG. 2 illustrates a trajectory of a magnetic head according to the first embodiment;

FIG. 3 illustrates a recording surface of a magnetic disk according to the first embodiment;

FIG. 4 schematically illustrates a method of writing data into each band according to the first embodiment;

FIG. 5 schematically illustrates an outline of an update operation according to the first embodiment;

FIG. 6 schematically illustrates each operation timing in the update operation according to the first embodiment;

FIG. 7 is a flowchart illustrating an exemplary operation of the magnetic disk device according to the first embodiment upon reception of data;

FIG. 8 is a flowchart of the update operation according to the first embodiment;

FIG. 9 schematically illustrates another exemplary method of accessing a recording surface according to the first embodiment;

FIG. 10 schematically illustrates an outline of an update operation according to a second embodiment;

FIG. 11 schematically illustrates each operation timing in the update operation according to the second embodiment; and

FIG. 12 schematically illustrates a configuration of a control circuit according to a third embodiment.

### DETAILED DESCRIPTION

According to one embodiment, in general, a magnetic disk device includes a magnetic disk, a first magnetic head, a second magnetic head, a buffer memory, and a control circuit. The magnetic disk includes a plurality of first storage regions. The control circuit controls the first magnetic head to read first data from a second storage region of the first storage regions to the buffer memory. The control circuit controls the second magnetic head to write second data to a third storage region concurrently with the reading of the first data. The third region is of the first storage regions, different from the second storage region. The second data corresponds to the first data stored in the buffer memory.

Exemplary embodiments of a magnetic disk device and a method for a magnetic disk device will be described below in detail with reference to the accompanying drawings. The following embodiments are merely illustrative and not intended to limit the scope of the present invention.

### First Embodiment

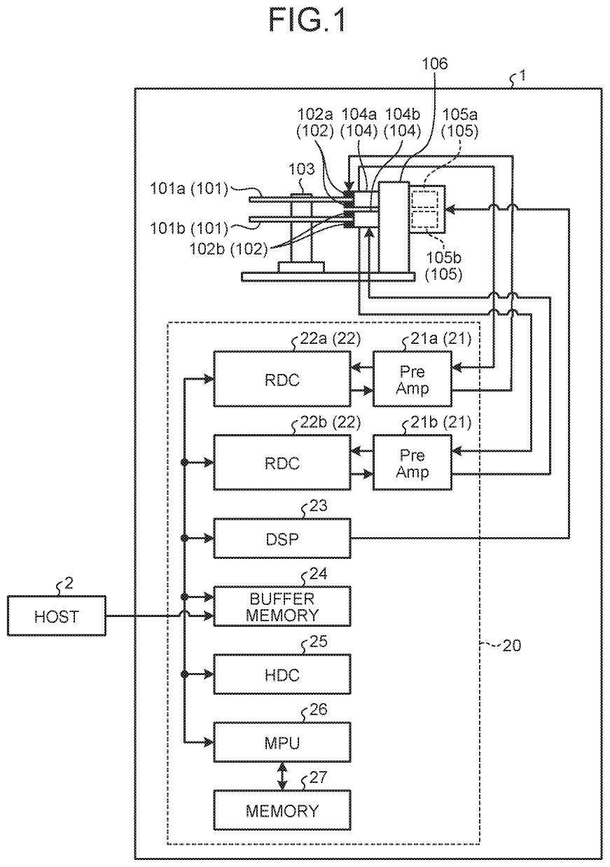

FIG. 1 illustrates an exemplary configuration of a magnetic disk device 1 according to a first embodiment. As illustrated in FIG. 1, the magnetic disk device 1 includes, for example, two magnetic disks 101, two pairs of magnetic heads 102 that read and write data, and two arms 104.

The two magnetic disks 101 include a magnetic disk 101a and a magnetic disk 101b. The two pairs of magnetic heads 102 include a pair of magnetic heads 102a and a pair of magnetic heads 102b. The two arms 104 include an arm 104a and an arm 104b.

The two magnetic disks 101 are attached to a rotation shaft 103 of a spindle motor with a given pitch in an axial direction of the rotation shaft 103. The spindle motor causes the two magnetic disks 101 to rotate together about the rotation shaft 103.

The number of magnetic disks 101 of the magnetic disk device 1 is not limited to two.

The magnetic heads 102a are attached to a distal end of the arm 104a. One of the magnetic heads 102a opposes a front surface of the magnetic disk 101a, and the other magnetic head 102a opposes a rear surface of the magnetic disk 101a. Each of the magnetic heads 102a reads and writes a signal corresponding to data from and to the magnetic disk 101a.

The magnetic heads 102b are attached to a distal end of the arm 104b. One of the magnetic heads 102b opposes a front surface of the magnetic disk 101b, and the other magnetic head 102b opposes a rear surface of the magnetic disk 101b. Each of the magnetic heads 102b writes a signal responsive to data into the magnetic disk 101b, and reads a signal corresponding to data from the magnetic disk 101b.

The magnetic disk device 1 includes two actuators 105, that is, an actuator 105a and an actuator 105b. Each of the actuator 105a and the actuator 105b is, for example, a voice coil motor (VCM). The actuator 105a and the actuator 105b operate independently of each other.

The actuator 105a causes the arm 104a to rotate about a shaft 106 to move the positions of the magnetic heads 102a relative to the recording surfaces of the magnetic disk 101a.

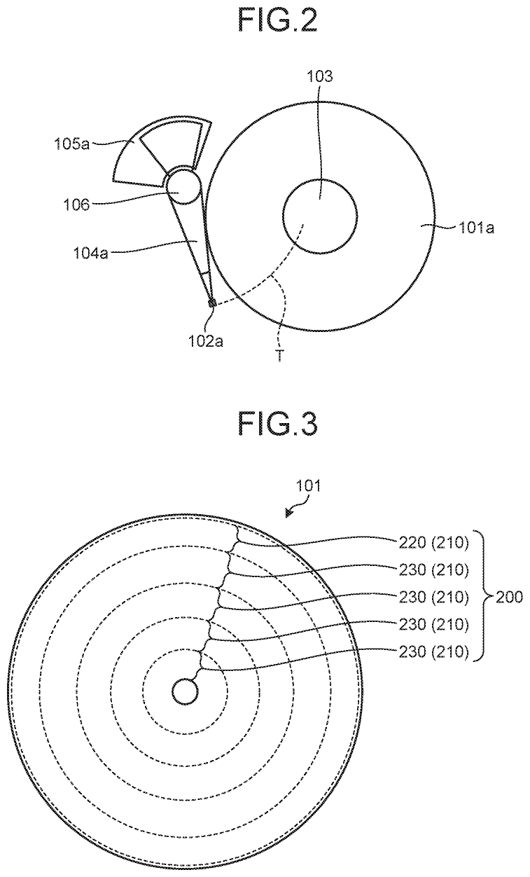

FIG. 2 illustrates a trajectory of the magnetic heads 102a according to the first embodiment, as viewed from the magnetic disk 101a along the shaft 106.

As illustrated in FIG. 2, the actuator 105a causes the arm 104a to rotate about the shaft 106 within a fixed range, so that the magnetic heads 102a move along a broken line T. The magnetic heads 102a are radially positioned on any track of the magnetic disk 101a.

The actuator 105b causes the arm 104b to rotate about the shaft 106 to move the positions of the magnetic heads 102b relative to the recording surfaces of the magnetic disk 101b. The magnetic heads 102b can thus follow the trajectory similar to that of the magnetic heads 102a.

Referring back to FIG. 1, the magnetic disk device 1 further includes a control circuit 20.

The control circuit 20 establishes communications with a host 2 via an interface for external connection, such as a contact pin, attached to a casing (not illustrated) of the magnetic disk device 1. Examples of the host 2 may include a server device, a mobile computer, and a processor. The control circuit 20 controls the respective components of the magnetic disk device 1 in accordance with, for example, a command from the host 2. Examples of the command may include a data write command and a data read command.

The control circuit 20 includes a preamplifier (PreAmp) 21 and a read channel circuit (RDC) 22 for each actuator 105. In other words, the control circuit 20 includes a preamplifier 21a and an RDC 22a for the actuator 105a. The control circuit 20 also includes a preamplifier 21b and an RDC 22b for the actuator 105b.

The control circuit 20 also includes a digital signal processor (DSP) 23, a buffer memory 24, a hard disk controller (HDC) 25, a micro processing unit (MPU) 26, and a memory 27.

The preamplifier 21a amplifies a signal read from the magnetic disk 101a by each of the magnetic heads 102a (read elements), and outputs the amplified signal to the RDC 22a. The preamplifier 21a amplifies the signal sent from the RDC 22a, and sends the amplified signal to each of the magnetic heads 102a (write elements).

The RDC 22a encodes data to be written into the magnetic disk 101a, and sends the encoded data as a signal to the preamplifier 21a. The RDC 22a decodes the signal read from the magnetic disk 101a and sent from the preamplifier 21a. The RDC 22a outputs the decoded signal as digital data to the HDC 25.

The preamplifier 21b amplifies and outputs a signal read from the magnetic disk 101b by each of the magnetic heads 102b (read elements), and sends the amplified signal to the RDC 22b. The preamplifier 21b amplifies a signal sent from the RDC 22b, and sends the amplified signal to each of the magnetic heads 102b (write elements).

The RDC 22b encodes data to be written into the magnetic disk 101b, and sends the encoded data as a signal to the preamplifier 21b. The RDC 22b decodes a signal read from the magnetic disk 101b and sent from the preamplifier 21b. The RDC 22b outputs the decoded signal as digital data to the HDC 25.

The DSP 23 controls the spindle motor and the respective actuators 105 to perform positioning control such as seek and following.

The buffer memory 24 serves as a buffer for, for example, data to be transferred to and from the host 2. Specifically, data transmitted from the host 2 is stored in the buffer memory 24. The data transmitted from the host 2 and stored in the buffer memory 24 is written into each of the magnetic disks 101. Read from each of the magnetic disks 101, the data is stored in the buffer memory 24. Read from each of the magnetic disks 101 and stored in the buffer memory 24, the data is output to the host 2.

The buffer memory 24 includes, for example, a high-speed operable memory. Type of the memory constituting the buffer memory 24 is not limited to a specific type. The buffer memory 24 may include, for example, a dynamic random access memory (DRAM) or a static random access memory (SRAM). The buffer memory 24 may not be located in the control circuit 20. The buffer memory 24 may be located outside the control circuit 20.

The HDC 25 is connected to the host 2 via a given interface to establish communications with the host 2. A standard to which the interface conforms is not limited to a specific standard. The HDC 25 receives data from each of the RDCs 22a and 22b, and stores the received data in the buffer memory 24. The HDC 25 transfers the data from the RDCs 22a and 22b to the host 2 from the buffer memory 24.

The HDC 25 receives data together with a write command from the host 2, and stores the received data in the buffer memory 24. That is, the buffer memory 24 receives data from the host 2. The HDC 25 outputs the data from the host 2 to the RDCs 22a and 22b from the buffer memory 24.

The MPU 26 serves as a processor that executes firmware i.e., a firmware program. The MPU 26 analyzes a command received from the host 2 by the HDC 25, to monitor the state of the magnetic disk device 1 and control the respective components of the magnetic disk device 1, for example.

The memory 27 functions as, for example, a region in which firmware and various kinds of management information are stored. The memory 27 includes a volatile memory, a nonvolatile memory, or a combination thereof. Examples of the volatile memory may include an SRAM and a DRAM. Examples of the nonvolatile memory may include a flash memory.

As described above, the pair of magnetic heads 102a and the pair of magnetic heads 102b are attached to the different arms 104. The arms 104 are driven by the different actuators 105. The preamplifiers 21 and the RDCs 22 are provided for the respective actuators 105.

Thereby, the control circuit 20 can independently control access to the magnetic disk 101a using the actuator 105a and the pair of magnetic heads 102a and access to the magnetic disk 101b using the actuator 105b and the pair of magnetic heads 102b. Thus, the control circuit 20 can control the actuator 105a and the actuator 105b to concurrently access the magnetic disk 101a and the magnetic disk 101b, for example.

FIG. 3 illustrates one of the recording surfaces of each magnetic disk 101 according to the first embodiment. The front surface and the rear surface of each magnetic disk 101 include recording surfaces 200. FIG. 3 illustrates one of the front surface and the rear surface of the magnetic disk 101.

The recording surface 200 is divided into a plurality of concentric storage regions 210 about the center of rotation of the magnetic disk 101. The storage regions 210 include one media cache region 220 and a plurality of bands 230. The recording surface 200 includes, between every two adjacent storage regions 210, a guard region in which data write operation is inhibited; however, FIG. 3 omit illustrating such guard regions. Each of the bands 230 is an example of a first storage region.

In the example illustrated in FIG. 3, the outermost storage region 210 serves as the media cache region 220 in the recording surface 200 of the magnetic disk 101. However, the location of the media cache region 220 is not limited thereto. The number of bands 230 in the recording surface 200 is four. However, the number of bands 230 is not limited thereto.

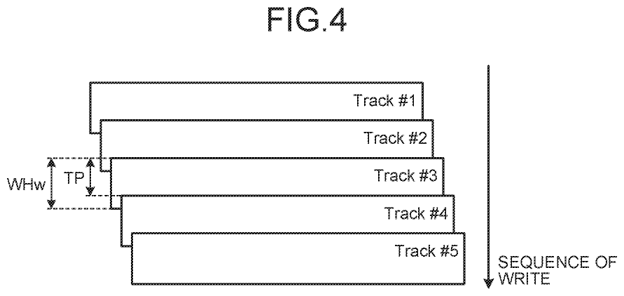

FIG. 4 schematically illustrates a method of writing data into each of the bands 230 according to the first embodiment.

Data is written to each of the bands 230 by shingled magnetic recording (SMR). SMR refers to a data recording method that allows the adjacent tracks to overlap with each other. It is apparent from FIG. 4 that, according to SMR, a track pitch (TP) is narrower than a core width (WHw) of the write element of each magnetic head 102. SMR enables decrease in track pitch and improvement in recording density.

The direction of track generation is not limited to a specific direction. The tracks may be sequentially set from radially outside to inside in each of the magnetic disks 101. Alternatively, the tracks may be sequentially set from radially inside to outside in each of the magnetic disks 101.

According to the SMR, the track pitch is narrower than the core width WHw of the write element. Consequently, in updating part of continuously written data in the tracks by the SMR, data in the tracks adjacent to the track storing the data to update may be damaged. For this reason, data is updated in unit of band 230.

For example, while certain data (referred to as old data) is written to a band 230, new data corresponding to the old data is sent. In this case, the new data is temporarily stored in a storage region, e.g., the media cache region 220, different from the band in question. Upon satisfaction of a given condition, all the data in the band 230 is transferred to a different band 230. In the transfer, the old data is replaced with the new data. This completes an update of the old data to the new data.

Each of the bands 230 includes a large number of tracks. As described above, the data update involves data transfer in unit of band 230. The data update therefore takes a large amount of time.

In view of this, according to the first embodiment, the control circuit 20 controls the different actuators 105 to read data from a band 230 being a transfer source and write data to a band 230 being a transfer destination. The control circuit 20 controls a data read operation from a source band 230 and a data write operation to a destination band 230 concurrently, which leads to reduction in a length of data update time.

Concurrent data read and write operations refer to starting a data write operation before completion of a data read operation. That is, there is a period in which data is read and written concurrently.

In the following, data update operation is referred to as update operation. Data in unit of band 230 is referred to as band data.

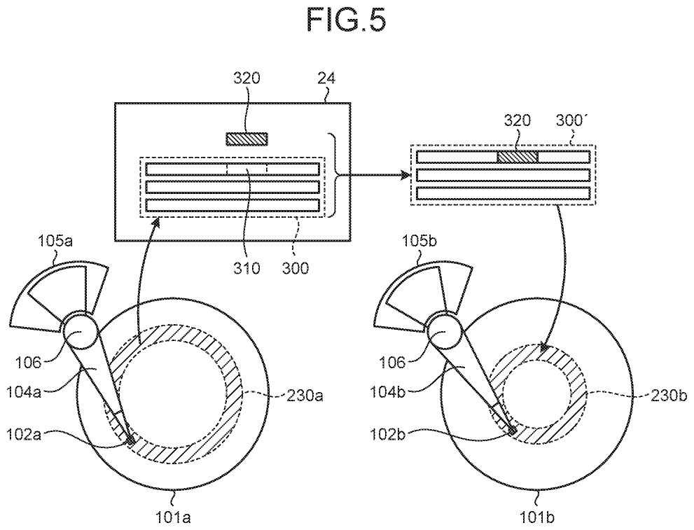

FIG. 5 schematically illustrates an outline of the update operation according to the first embodiment.

For example, to update part (old data 310) of band data 300 to new data 320 in a band 230a of the magnetic disk 101a through an update operation, the control circuit 20, e.g., the HDC 25 controls a read operation of the band data 300 from the band 230a to the buffer memory 24. The HDC 25 uses the actuator 105a to read the band data 300. The HDC 25 stores the read band data 300 in the buffer memory 24.

The control circuit 20, e.g., the MPU 26 selects a band 230 as a transfer destination of the band data 300, from the bands 230 accessible by the actuator 105b, that is, from the bands 230 in the magnetic disk 101b. The band 230 thus selected in the magnetic disk 101b is referred to as a band 230b.

The control circuit 20, e.g., the HDC 25, reflects the new data 320, pre-stored in the buffer memory, 24, on the band data 300 stored in the buffer memory 24. Specifically, the control circuit 20 replaces the old data 310 of the band data 300 with the new data 320. The control circuit 20 writes, to the band 230b, the band data 300 including the new data 320 replacing the old data 310 as band data 300′.

The new data 320 is sent from the host 2 after the band data 300 is stored in the band 230a, and is overwritten to the old data 310. In other words, the new data 320 is equivalent to an update to the band data 300 stored in the band 230a.

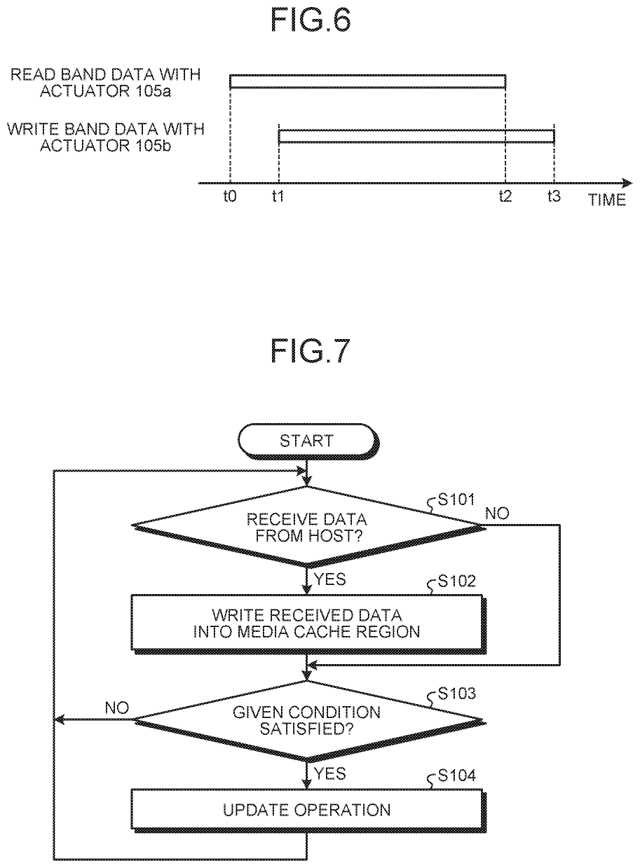

FIG. 6 schematically illustrates band data read timing and band data write timing in the update operation according to the first embodiment.

For example, at time t0, a read operation of band data 300 with the actuator 105a starts. A write operation of the band data 300 may start as long as the band data 300 is partially stored in the buffer memory 24. Thus, a write operation of the band data 300 with the actuator 105b starts before completion of reading the band data 300. In the example illustrated in FIG. 6, the write operation of the band data 300 starts immediately after the start of reading the band data 300 (time t1).

In writing the band data 300, new data 320 is appropriately reflected on the band data 300. For example, the control circuit 20 transfers part of the band data 300, excluding old data 310, from the buffer memory 24 to the band 230b. The control circuit 20 then transfers the new data 320 to the band 230b in place of the old data 310. The control circuit 20 thus reflects the new data 320 on the band data 300.

After the start of a write operation of the band data 300, the read operation of the band data 300 terminates at time t2. At time t3, the write operation of the band data 300 terminates. The update operation thus ends.

In reading and writing the band data 300 using the same actuator 105, the band data 300 are read and written serially. In this case, the update operation requires a length of time exceeding a sum of the time for reading the band data 300 and the time for writing the band data 300.

In the example illustrated in FIG. 6, the band data 300 is read and written concurrently in the period from the time t1 to the time t2. This results in reduction in the length of time for the update operation as compared with reading and writing the band data 300 serially.

Each of the bands 230 contains data of the plurality of tracks. The band data 300 is therefore considerably large in size. The capacity of the buffer memory 24 may be smaller than the size of the band data 300, and the band data 300 may be read and written with the same actuator 105. In such a case, the band data 300 is divided into regions of a size smaller than the capacity of the buffer memory 24, and each division is repeatedly subjected to read and write operations.

In the first embodiment, a write operation of the band data 300 can start before the completion of a read operation of the band data 300. Thus, in the case of the buffer memory 24 with a smaller capacity, the update operation can be performed without the band data 300 divided.

Next, a description will be given of the operation of the magnetic disk device 1 according to the first embodiment.

FIG. 7 is a flowchart illustrating an exemplary operation of the magnetic disk device 1 according to the first embodiment in response to reception of data.

First, data is received from the host 2 and stored in the buffer memory 24. When the buffer memory 24 stores the data received from the host 2 (Yes in S101), the control circuit 20 controls a write operation of the data to one of the media cache regions 220 (S102).

Any media cache region 220 is appropriately selected as a write destination. The control circuit 20 can select, as a write destination, one of the media cache regions 220 in the recording surfaces 200 on the front and rear surfaces of the magnetic disk 101a or the magnetic disk 101b.

When the buffer memory 24 stores no data received from the host 2 (No in S101) or after S102, the control circuit 20 determines whether a given update condition is satisfied (S103).

The update condition may be set to any condition. For example, the update condition may be such that the amount of written data in the media cache region 220 reaches a given amount. Alternatively, the update condition may be such that no receipt of commands from the host 2 continues for a given period or more.

After satisfaction of the update condition (Yes in S103), the control circuit 20 performs the update operation (S104). Upon no satisfaction of the update condition (No in S103) or after S104, S101 is carried out again.

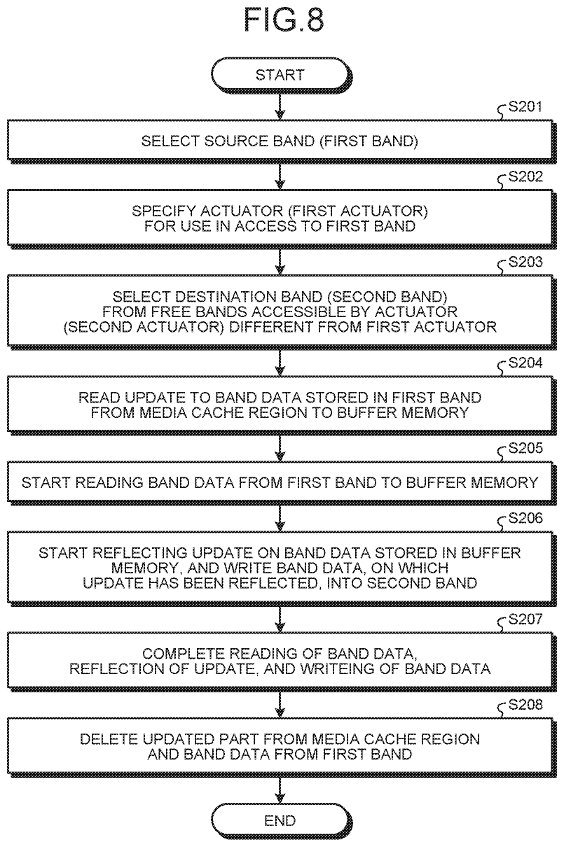

FIG. 8 is a flowchart of the update operation according to the first embodiment.

First, the control circuit 20 selects a band 230 as a transfer source (S201). The band 230 selected in S201 is referred to as a first band.

Next, the control circuit 20 specifies an actuator 105 for use in accessing the first band (S202). For example, when the first band is of the recording surfaces 200 of the magnetic disk 101a, the control circuit 20 determines the actuator 105a as an actuator 105 for use in accessing the first band. When the first band is of the recording surfaces 200 of the magnetic disk 101b, the control circuit 20 determines the actuator 105b as an actuator 105 for use in accessing the first band. The actuator 105 specified in S202 is referred to as a first actuator. Each magnetic head 102 to be moved by the first actuator is referred to as a first magnetic head.

Next, the control circuit 20 selects a band 230 as a transfer destination from free bands 230 accessible by an actuator different from the first actuator (S203). The free bands 230 refer to bands 230 in which band data is storable. For example, the free bands 230 are bands 230 storing no written data or from which band data has been deleted.

The actuator different from the first actuator and selected in S203 is referred to as a second actuator. Each magnetic head 102 to be moved by the second actuator is referred to as a second magnetic head. The destination band 230 selected in S203 is referred to as a second band.

Next, the control circuit 20 controls a read operation of data, equivalent to an update to the band data stored in the first band, from the media cache region 220 to the buffer memory 24 (S204).

The data is received from the host 2 and stored in the media cache region 220 in S102 of FIG. 7. In S204, the control circuit 20 specifies, from the data stored in the media cache region 220, the data equivalent to the update to the band data stored in the first band.

For example, all the items of data received from the host 2 are correlated with logical addresses. The logical address refers to information indicating a location in a logical address space to be provided from the magnetic disk device 1 to the host 2. The logical addresses are correlated with data in units of sector. The data in units of sector is referred to as sector data.

The control circuit 20 stores therein a correspondence between data and a logical address for each sector data stored in the magnetic disks 101. When the media cache region 220 stores sector data correlated with the same logical address as that of sector data in the first band, the control circuit 20 regards the sector data stored in the media cache region 220, as the update to the band data stored in the first band. The control circuit 20 retrieves the sector data correlated with the same logical address as that of the sector data stored in the first band, thereby specifying the update to the band data stored in the first band.

The foregoing specifying method is merely illustrative. The control circuit 20 can specify the update to the band data stored in the first band by any method. For example, in storing, in the media cache region 220 in S102 of FIG. 7, the sector data correlated with the same logical address as that of the sector data written to any of the bands 230, the control circuit 20 may record this fact as management information, and specify the update to the band data stored in the first band on the basis of the management information in S204.

Subsequent to S204, the control circuit 20 starts controlling a read operation of the band data from the first band to the buffer memory 24 (S205). The control circuit 20 allows the first actuator and the first magnetic head to read the band data from the first band.

Next, the control circuit 20 starts controlling a reflection of the updated part on the band data 300 stored in the buffer memory 24 and a write operation of the band data, on which the updated part has been reflected, into the second band (S206). The control circuit 20 allows the second actuator and the second magnetic head to write the band data, on which the updated part has been reflected, into the second band.

After completion of the read operation of the band data, the reflection of the updated part, and the write operation of the band data on which the updated part has been reflected (S207), the control circuit 20 controls deletion of the band data 300 from the first band 230 (S208). The update operation thus ends.

The foregoing embodiment has described the example that the pair of magnetic heads 102a and the pair of magnetic heads 102b are independently moved by the different actuators 105. However, the number of independently movable magnetic heads 102 is not limited to two. The magnetic disk device 1 may include three or more magnetic heads 102 and actuators 105 for the respective magnetic heads, and the magnetic heads 102 are movable independently of one another. For example, the control circuit 20 may use any two of the three or more magnetic heads 102 to implement the operation described above.

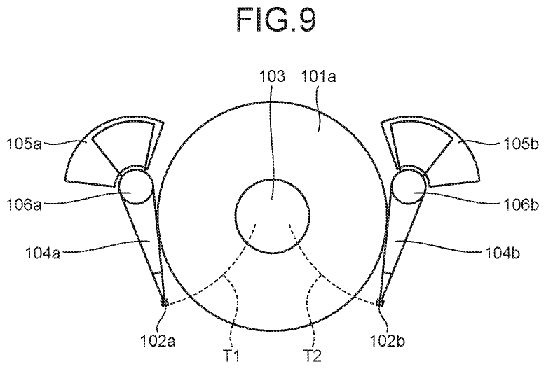

The foregoing embodiment has described the magnetic disk device 1 including the arm 104a and the arm 104b with the common rotation shaft, by way of example. In order to enable the different actuators 105 to concurrently access the same recording surface 200, the magnetic disk device 1 may include the arm 104a with a rotation shaft 106a and the arm 104b with a rotation shaft 106b as illustrated in, for example, FIG. 9. In this case, a destination band 230 and a source band 230 are selectable from the same recording surface 200.

The foregoing embodiment has described the example that the control circuit 20 controls a read operation of the updated part of the band data from the media cache region 220 to the buffer memory 24 before starting a read operation of the band data. However, the updated-part read timing is not limited to such an example. For example, the control circuit 20 may interrupt a read operation or a write operation of the band data, and resume the interrupted read or write operation after reading the updated part from the media cache region 220 to the buffer memory 24. Which one of the read and write operations of the band data is to be interrupted is determined depending on the actuator 105 used in reading the updated part. When the recording surface 200, accessible by the actuator 105 for use in reading the band data, stores the updated part, the control circuit 20 interrupts a read operation of the band data. When the recording surface 200, accessible by the actuator 105 for use in writing the band data, stores the updated part, the control circuit 20 interrupts a write operation of the band data.

The data received from the host 2 is not necessarily written to the media cache region 220. The control circuit 20 may hold the data received from the host 2 in the buffer memory 24, thereby omitting reading the updated part from the media cache region 220 to the buffer memory 24 in the update operation.

The foregoing embodiment has described the example of writing data by SMR. The first embodiment is applicable to a magnetic disk device that writes data by conventional magnetic recording (CMR).

For example, stored data may be transferred from a magnetic disk to another region for some reason, irrespective of SMR or CMR writing. To transfer data, as with the data update operation described above, different actuators serve to read data from the current region to the buffer memory and write data from the buffer memory to another region concurrently. This makes it possible to reduce the data transfer time.

According to the first embodiment, thus, a control circuit (e.g., the control circuit 20) concurrently controls a read operation of first data from a certain region to a buffer memory (e.g., the buffer memory 24), and a write operation of second data corresponding to the first data from the buffer memory to another region. The second data corresponding to the first data may be equal to the first data or may be first data on which an updated part has been reflected, such as the band data 300′.

The control circuit 20 may not constantly control the different actuators 105 for use in reading band data and writing band data. The control circuit 20 may determine whether to perform such control in accordance with, for example, a command from the host 2.

The foregoing embodiment has not specifically described a writing method of data to a media cache region 220. The writing method to a media cache region 220 is not limited to a specific method. For example, data is written into a media cache region 220 by CMR.

As described above, according to the first embodiment, the control circuit 20 controls a write operation of band data from the buffer memory 24 to a destination band 230 concurrently with a read operation of band data from a source band 230 to the buffer memory 24.

This can reduce a length of time taken for the update operation. In other words, the performance of the magnetic disk device 1 can be improved.

In addition, the control circuit 20 controls storing of an updated part of band data in the buffer memory 24, a reflection of the updated part on the band data stored in the buffer memory 24, and a write operation of the band data, on which the updated part has been reflected, to a destination band 230.

This enables reduction in the length of time for the update operation in the magnetic disk device 1 that adopts the SMR.

The control circuit 20 controls a write operation of data received from the host 2 to a media cache region 220. In the update operation, the control circuit 20 controls a read operation of data equivalent to an updated part of band data, of the data written to the media cache region 220, from the media cache region 220 to the buffer memory 24.

This enables reduction in the length of time for the update operation in the magnetic disk device 1 that adopts the SMR.

### Second Embodiment

The first embodiment describes reading band data from a source band 230 to the buffer memory 24 and writing band data from the buffer memory 24 to a destination band 230 concurrently, by way of example.

The magnetic disk device 1 may include three or more actuators 105 that are operable independently of one another. In such a case, the control circuit 20 may be configured to concurrently control a read operation of an updated part from a media cache region 220 to the buffer memory 24, a read operation of band data from a source band 230 to the buffer memory 24, and a write operation of the band data from the buffer memory 24 to a destination band 230.

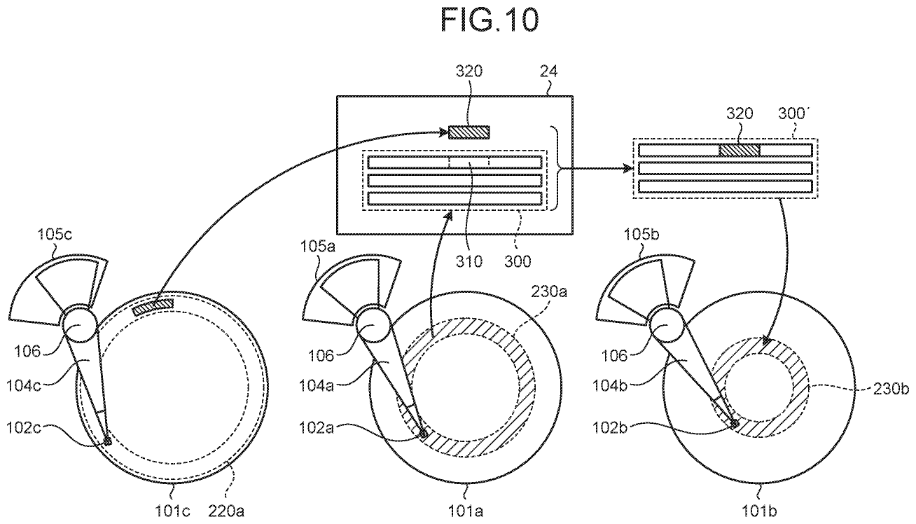

FIG. 10 schematically illustrates an outline of an update operation according to a second embodiment.

A magnetic disk device 1 includes a magnetic disk 101c in addition to magnetic disks 101a and 101b. The magnetic disk device 1 also includes an arm 104c in addition to arms 104a and 104b. The arm 104c is driven by an actuator 105c different from actuators 105a and 105b. A pair of magnetic heads 102c is attached to a distal end of the arm 104c, opposing the recording surfaces 200 of the magnetic disk 101c. A control circuit 20 drives the actuator 105c to move the magnetic heads 102c. Specifically, the magnetic disk device 1 can allow the actuator 105a, the actuator 105b, and the actuator 105c to concurrently access the magnetic disk 101a, the magnetic disk 101b, and the magnetic disk 101c, respectively.

The control circuit 20 controls a write operation of band data and updating of the band data to the recording surfaces 200 accessible by the different actuators 105. In the update operation, thus, the different actuators 105 can serve to concurrently read the band data and the update.

In addition, the control circuit 20 selects a band 230 to be a transfer destination of band data from the bands 230 accessible by an actuator 105 different from an actuator 105 for use in accessing a band 230 being a transfer source of the band data and an actuator 105 for use in reading an updated part of the band data. Thus, the different actuators 105 can serve to read the band data and the updated part, and write the band data concurrently.

In the example illustrated in FIG. 10, a media cache region 220 (referred to as a media cache region 220a) of the magnetic disk 101c stores new data 320 corresponding to an update to the band data 300 stored in a band 230a. In other words, the actuator 105a is used for reading the band data 300, and the actuator 105c and the magnetic heads 102c are used for reading the updated part.

The control circuit 20 selects, as a transfer destination of the band data 300, a band 230b being the band 230 accessible by the other actuator 105, i.e., the actuator 105b.

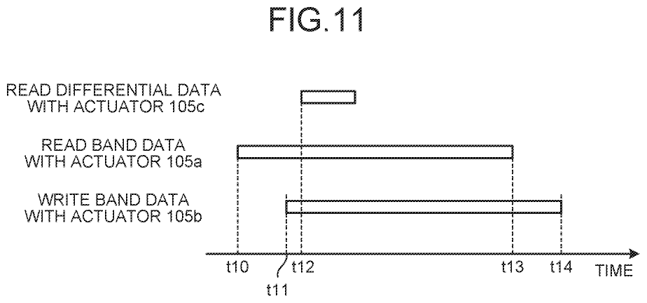

FIG. 11 schematically illustrates each operation timing in the update operation according to the second embodiment.

For example, at time t10, a read operation of band data 300 with the actuator 105a starts. Next, a write operation of the band data 300 starts immediately after the start of reading the band data 300 (time t11).

In writing the band data 300, new data 320 is appropriately reflected on the band data 300. The new data 320 is read at any timing before the new data 320 is written. In the example illustrated in FIG. 11, the new data 320 is read with the actuator 105c after time t12. The actuator 105a and the actuator 105c operate independently of each other. Thus, the new data 320 may be read at or before the time t10.

In the example illustrated in FIG. 11, the band data 300 is read and written concurrently even after the new data 320 is read. At time t13, the read operation of the band data 300 ends. At time t14, the write operation of the band data 300 ends. The update operation thus ends.

As illustrated in FIG. 11, at time t12, the new data 320 (i.e., the updated part) is read from the media cache region 220 to the buffer memory 24, the band data 300 is read from the source band 230 to the buffer memory 24, and the band data 300 is written from the buffer memory 24 to the destination band 230 concurrently.

According to the second embodiment, the updated part can be read with no interruption of the read and write operations of the band data 300, which can further reduce the length of time for the update operation.

### Third Embodiment

In the first embodiment, among the constituent elements of the control circuit 20, the preamplifiers 21 and the RDCs 22 are multiplexed. However, constituent elements to be multiplexed are not limited to the preamplifiers 21 and the RDCs 22.

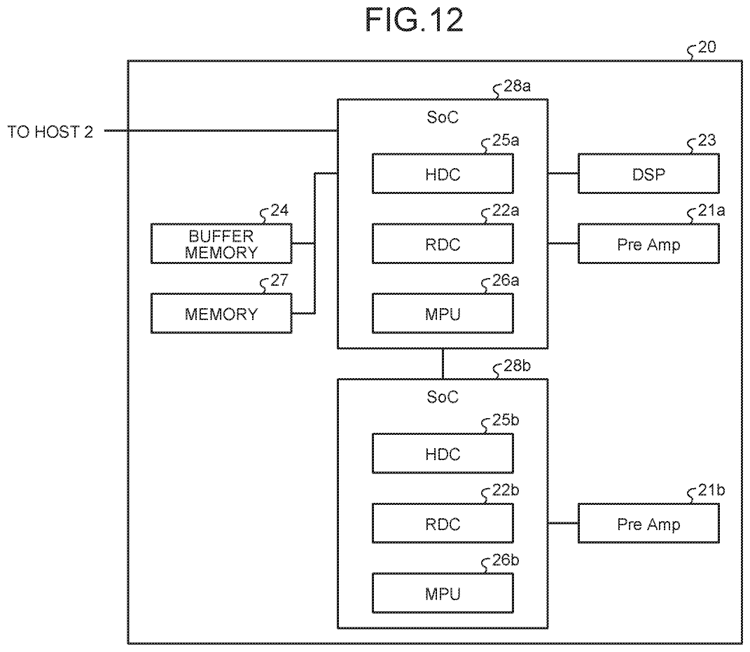

FIG. 12 schematically illustrates a configuration of a control circuit 20 according to a third embodiment. The control circuit 20 includes preamplifiers 21a and 21b, a DSP 23, a buffer memory 24, and a memory 27. The control circuit 20 also includes two systems-on-a-chip (SoCs), that is, an SoC 28a and an SoC 28b.

The SoC 28a and the SoC 28b have the same hardware configuration. Specifically, the SoC 28a includes an HDC 25a, an RDC 22a, and an MPU 26a. The SoC 28b includes an HDC 25b, an RDC 22b, and an MPU 26b.

Depending on mode settings, the SoC 28a functions as a host device, and the SoC 28b functions as a slave device to the SoC 28a.

Specifically, the SoC 28a causes the SoC 28b to perform the access control over the actuator 105b, among the functions of the HDC 25 and MPU 26 of the control circuit 20 according to the first embodiment. The SoC 28a performs access control over an actuator 105a, exchange of information with a host 2, and control of a spindle motor, for example.

In the case of magnetic disk device 1 including three or more independently operable actuators 105, the number of SoCs 28 may be three or more.

As described above, of the constituent elements of the control circuit 20, any constituent elements may be appropriately multiplexed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a magnetic disk including a plurality of first storage regions;
a first magnetic head;
a second magnetic head;
a buffer memory; and
a control circuit that:
controls the first magnetic head to read first data from a second storage region of the first storage regions to the buffer memory, and
controls the second magnetic head to write second data to a third storage region concurrently with the reading of the first data, the third region being of the first storage regions, different from the second storage region, the second data corresponding to the first data stored in the buffer memory.

2. The magnetic disk device according to claim 1, further comprising:
a first actuator that moves the first magnetic head;
a second actuator that moves the second magnetic head.

3. The magnetic disk device according to claim 2, wherein
the first actuator and the second actuator operate independently of each other.

4. The magnetic disk device according to claim 1, wherein
the control circuit controls a data write operation to each of the first storage regions by shingled magnetic recording, and
the control circuit controls an update operation on the data stored in the first storage regions in unit of first storage regions.

5. The magnetic disk device according to claim 4, wherein
the control circuit controls storing of third data in the buffer memory and reflection of the third data on the first data stored in the buffer memory, the third data corresponding to an update to the first data in the buffer memory, and
the second data is the first data on which the third data has been reflected.

6. The magnetic disk device according to claim 5, wherein
the magnetic disk includes a fourth storage region different from the first storage regions,
the third data corresponds to an update to the first data, the update being received from a host after the first data is stored in the second storage region, and
in response to receipt of the third data from the host, the control circuit controls a write operation of the third data to the fourth storage region, and then controls a read operation of the third data from the fourth storage region to the buffer memory.

7. The magnetic disk device according to claim 6, further comprising:
a third magnetic head;
a third actuator that moves the third magnetic head, wherein
the control circuit controls the third magnetic head and the third actuator to read the third data from the fourth storage region to the buffer memory concurrently with the reading of the first data.

8. A magnetic disk device comprising:
a magnetic disk including a first region and a second region different from the first region;
a first magnetic head;
a second magnetic head;
a buffer memory; and
a control circuit that controls the first magnetic head and the second magnetic head to read and write data from and to the magnetic disk, wherein
the first magnetic head reads first data from the first region,
the control circuit stores the first data in the buffer memory, and
the second magnetic head writes second data corresponding to the first data to the second region before completion of storing the first data in the buffer memory.

9. The magnetic disk device according to claim 8, further comprising:
a first actuator that moves the first magnetic head;
a second actuator that moves the second magnetic head.

10. The magnetic disk device according to claim 9, wherein
the first actuator and the second actuator operate independently of each other.

11. A method for controlling a magnetic disk device comprising a magnetic disk including a plurality of first storage regions; a first magnetic head; a second magnetic head; a first actuator that moves the first magnetic head; a second actuator that moves the second magnetic head; and a buffer memory,
the method comprising:
controlling the first magnetic head and the first actuator to read first data from a second storage region of the first storage regions to the buffer memory; and
controlling the second magnetic head and the second actuator to write second data to a third storage region concurrently with the reading of the first data, the second data corresponding to the first data stored in the buffer memory, the third storage region being of the first storage regions, different from the second storage region.

12. The method according to claim 11, further comprising:
controlling a data write operation to each of the first storage regions by shingled magnetic recording; and
controlling an update operation on the data stored in the first storage regions in unit of first storage regions.

13. The method according to claim 12, further comprising:
controlling storing of third data in the buffer memory and reflection of the third data on the first data stored in the buffer memory, the third data corresponding to an update to the first data in the buffer memory, wherein
the second data is the first data on which the third data has been reflected.

14. The method according to claim 13, wherein
the magnetic disk includes a fourth storage region different from the first storage regions, and
the third data corresponds to an update to the first data, the update being received from a host after the first data is stored in the second storage region,
the method further comprising:
in response to receipt of the third data from the host, controlling a write operation of the third data to the fourth storage region, and controlling a read operation of the third data from the fourth storage region to the buffer memory.

15. The method according to claim 14, wherein
the magnetic disk device further includes a third magnetic head, and a third actuator that moves the third magnetic head,
the method further comprising:
controlling the third magnetic head and the third actuator to read the third data from the fourth storage region to the buffer memory, concurrently with the reading of the first data.
